(19) United States
(12) Patent Application Publication
(10) Pub. No.: US 2017/0171356 A1
(43) Pub. Date: Jun. 15, 2017

(54) INTERACTION METHOD AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Xuan JI, Beijing (CN); Shaolong ZHU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,084

(22) Filed: Aug. 22, 2016

Related U.S. Application Data
(63) Continuation of application No. PCT/CN2016/089529, filed on Jul. 10, 2016.

(30) Foreign Application Priority Data
Dec. 15, 2015 (CN) 2015109316589

(51) Int. Cl. H04L 29/06; H04L 12/58; H04L 29/08

(52) U.S. Cl. CPC H04L 67/42; H04L 67/10; H04L 51/046

(57) ABSTRACT

In the field of program interaction, a method and electronic device for interaction are provided. The interaction method includes: when a client is in a shaking state, acquiring information in a currently played program; the client sending the information in the currently played program to a server; and the server presenting program interaction information related to the information in the currently played program on the client according to the information in the currently played program.

### CROSS-REFERENCE TO RELATED APPLICATIONS

The present disclosure is a continuation of PCT application No. PCT/CN2016/089529 submitted on Jul. 10, 2016. The present disclosure claims priority to Chinese Patent Application No. 201510931658.9, filed with the Chinese Patent Office on Dec. 15, 2015, which is incorporated herein by reference in its entirety.

### TECHNICAL FIELD

The present patent disclosure relates to the field of program interaction, and specifically, to an interaction method and electronic device.

### BACKGROUND

With the rapid development of electronic products and network technologies, an entertaining property of a program is also greatly improved. While watching a video program, a user may participate in the program by a client, thereby implementing interaction between the user and the program or other users. For example, a user may scan a two-dimensional code that appears in a video, and after the scanning, a client may jump to an application related to the video according to information of the two-dimensional code, thereby implementing interaction between the user and a video program.

In addition, a Shake function launched by WeChat, by means of shaking a mobile phone or clicking a button to simulate a shake, may match a WeChat user that triggers this function at the same time segment, thereby improving interaction between users and viscosity of WeChat. Based on the above, popularity of shaking for a red envelope is aroused, and such an activity is merely based on timelines. Within a specified time, a user acquires a red envelope by means of the Shake function.

However, in a case in which program interaction is performed by scanning a two-dimensional code, a user has to enable a scanning function of a client to complete scanning by aiming at the two-dimensional code, so as to implement interaction. In such a manner, the user has more processing steps and while the two-dimensional code is scanned, attention of the user to a program may be affected, which may cause that the user misses content of information of interest. However, with regard to a case in which interaction is implemented by shaking for a red envelope, which has unfavorable flexibility because it is based on content selected within a time limit, reception of a red envelope needs to be implemented within a specific time segment based on a specific selection of the user on the client.

### SUMMARY

The present disclosure provides a method and electronic device for interaction, which can implement interaction between a user and a program and between users conveniently and quickly.

According to a first aspect, the embodiments of the present application provide an interaction method, where the interaction method includes: when a client is in a shaking state, acquiring information in a currently played program; the client sending the information in the currently played program to a server; and the server presenting program interaction information related to the information in the currently played program on the client according to the information in the currently played program.

According to a second aspect, some embodiments of the present disclosure further provides a non-volatile computer storage medium, which stores computer executable instructions, where the computer executable instructions are configured to execute any of the foregoing interaction method of the present application.

According to a third aspect, some embodiments of the present application further provides an electronic device, including: at least one processor; and a memory, where the memory stores instructions that can be executed by the at least one processor, and the execution of the instructions by the at least one processor causes the at least one processor to perform any of the foregoing interaction method of the present disclosure.

Other features and advantages of some embodiments of the present disclosure are described in detail in the Detailed Description part below.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

Accompanying drawings are used to provide further understanding on the present disclosure, constitute a part of the description, and are used, together with the following specific implementation manners, to explain the present disclosure, but do not constitute limitations to the present disclosure, wherein:

FIG. 1 is a flowchart of an interaction method provided by the present application;

FIG. 2 is a flowchart of an interaction method provided by the present application; and

FIG. 3 is a structural block diagram of an interaction system provided by the present application.

FIG. 4 is a structural block diagram of an electronic device provided by the present application.

Description of the reference signs

| | | | |
|---|---|---|---|
| 30 | client | 40 | server |

### DETAILED DESCRIPTION

To make the objectives, technical solutions, and advantages of the present application more comprehensible, the technical solutions of the present application are described clearly and completely below by referring to the accompanying figures in the embodiments of the present application. Obviously, the described embodiments are only some rather than all of the embodiments of the present application.

Specific implementation manners of the present application are described in detail below with reference to the accompanying drawings. It should be understood that the specific implementation manners described herein are merely used to describe and explain the present application rather than limit the present application.

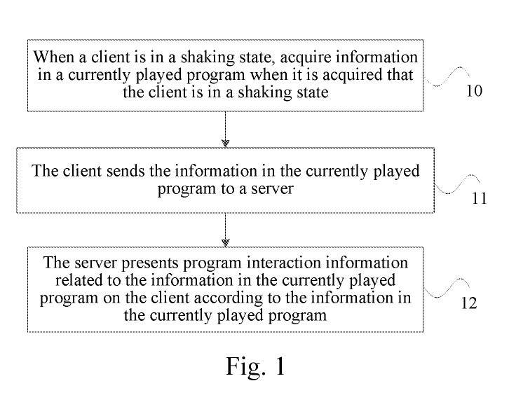

FIG. 1 is a flowchart of an interaction method according to some embodiments of the present disclosure. As shown in FIG. 1, the interaction method provided by some embodiments may include: in step 10, when a client is in a shaking state, acquiring information in a currently played program; in step 11, the client sending the information in the currently played program to a server; and in step 12, the server presenting program interaction information related to the information in the currently played program on the client according to the information in the currently played program.

By means of the interaction method provided in some embodiments, during a process in which a program is broadcast live or on demand, if a user wants to participate in program interaction, the user only needs to shake a client (for example, an intelligent terminal such as a mobile phone or a tablet computer, etc.), so as to enable the client to automatically acquire information in a currently played program, and then, based on the information, program interaction information to be pushed to the client and presented to the user by the client, so as to help the user involve in, for example, making a selection in a talent show, commenting on a film or drama program, participating in a game program, or the like. Such convenient implementation of program interaction is unlikely to affect acquiring, by a user, content of a program itself, thereby greatly improving user experience and attraction of the program.

The information in the currently played program is audio information, and certainly, some embodiments are not limited thereto. Persons skilled in the art can use other suitable information, such as video information, as to-be-acquired information.

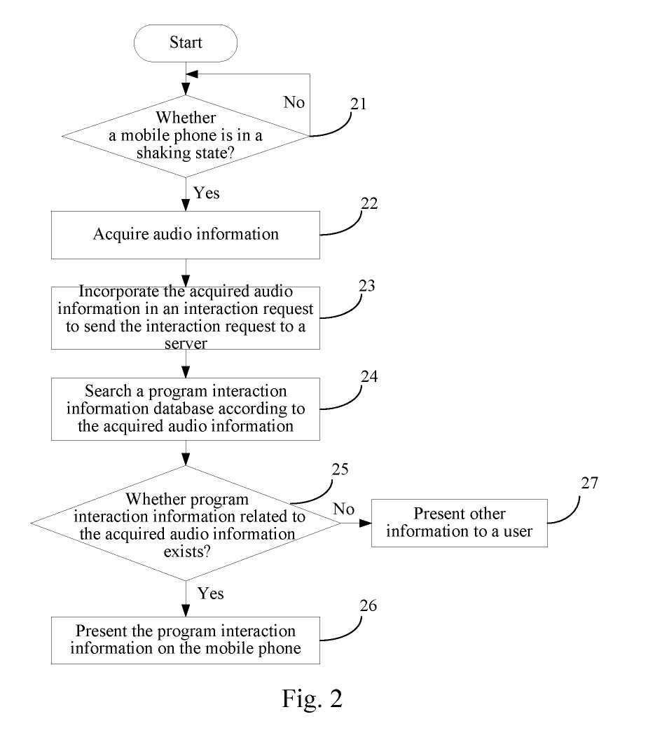

An example in which a mobile phone serves as a client and audio information is acquired information is used to describe some embodiments below in detail by referring to FIG. 2.

In some embodiments, while watching a live program or an on-demand program, a user may participate in interaction of a currently played program at any time. Specifically, as shown in FIG. 2, in step 21, whether the mobile phone is in a shaking state is determined; while watching the program, if the user wants to participate in the interaction of the currently played program, the user may shake the mobile phone. In this way, the mobile phone can determine that it is in a shaking state. Moreover, when the mobile phone determines whether it is in a shaking state, the mobile phone can determines that it is in a shaking state only when a shaking amplitude, a shaking frequency, and/or a number of shakes reach/reaches a preset range(s), thereby avoiding mistaken determination.

After it is determined that the mobile phone is in a shaking state, in step 22, audio information in the currently played program may be acquired by means of, for example, but not limited to, recording; and in step 23, the mobile phone may incorporate the acquired audio information into an interaction request to send the interaction request to the server, so as to request the server to push interaction information related to the currently played program to the mobile phone.

After receiving the acquired audio information, in step 24, the server searches a program interaction information database according to the acquired audio information, where the program interaction information database may pre-store audio information of different programs or audio information-related information such as specific music, textual language or the like, and certainly, the program interaction information database may store other information, so as to match the acquired information.

In step 25, it is determined whether program interaction information related to the acquired audio information exists in the program interaction information database. This determining process may be determining whether the acquired audio information matches certain audio information stored in the program interaction information database or determining whether characteristic information (such as specific music, textual language, etc.) extracted from the acquired audio information matches information related to certain audio information stored in the program interaction information database.

If it is determined that the program interaction information related to the acquired audio information exists in the program interaction information database, in step 26, the found program interaction information, for example, an interaction page related to the program is presented on the mobile phone, enabling the user to participate in the program interaction by the interaction page. If, in step 25, it is determined that the program interaction information related to the acquired audio information does not exist in the program interaction information database, in step 27, other information, such as the program interaction information being expired and a prompt for a user to acquire the information in the currently played program again, is presented by the mobile phone.

By means of the interaction method provided by some embodiments, a user only needs to shake a client to acquire corresponding interaction information based on acquired, for example, audio information and does not need to perform other operations, thereby reducing complexity of user operations and an influence on program acquisition and improving initiative of the user in participating in program interaction.

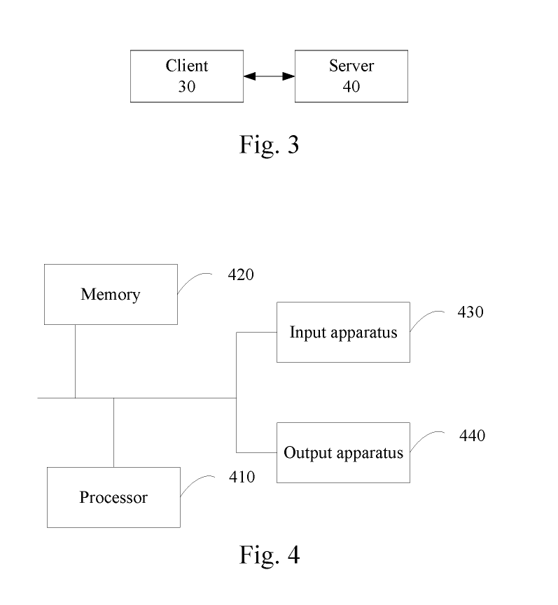

Some embodiments of the present disclosure further provide an interaction system. FIG. 3 is a structural block diagram of an interaction system according to some embodiments of the present disclosure. As shown in FIG. 3, the interaction system may include: a client 30 configured to, when being in a shaking state, acquire information in a currently played program and send the information in the currently played program to a server; and a server 40 configured to present program interaction information related to the information in the currently played program on the client according to the information in the currently played program.

By means of the interaction system provided in some embodiments, during a process in which a program is broadcast live or on demand, if a user wants to participate in program interaction, the user only needs to shake a client (for example, an intelligent terminal such as a mobile phone, a tablet computer or the like), so as to enable the client to automatically acquire information in a currently played program, and then, based on the information, program interaction information to be pushed to the client and presented to the user by the client, so as to help the user involve in, for example, making a selection in a talent show, commenting on a film or drama program, participating in a game program, or the like. Such convenient implementation of program interaction is unlikely to affect acquiring, by a user, content of a program itself, thereby greatly improving user experience and attraction of the program.

Specific details and advantages related to the interaction system are the same as the foregoing details and advantages of the interaction method, and are not described herein again.

Although preferable implementation manners of the present disclosure have been described in detail above with reference to the accompanying drawings, the present disclosure is not limited to specific details in the foregoing implementation manners. Various simple variations can be made to the technical solutions of the present disclosure within the scope of the technical concept of the present disclosure, and such simple variations all fall within the protection scope of the present disclosure.

It should be further noted that the various specific technical features described in the foregoing specific implementation manners can be combined in any appropriate manner without conflict. To avoid unnecessary repetition, various possible combination manners will not be described in the present disclosure.

In addition, various different implementation manners of the present disclosure may also be combined arbitrarily and such combinations shall also be considered as the content disclosed by the present disclosure as long as these combinations do not depart from the concept of the present disclosure.

Some embodiments of the application provides a non-volatile computer storage medium, which stores a computer executable instruction, where the computer executable instruction can execute the interaction method in any of the foregoing method embodiments.

FIG. 4 is a schematic structural diagram of hardware of a method and electronic device for executing an interaction provided in some embodiments of the application. As shown in FIG. 4, the electronic device includes:

one or more processors 410 and a memory 420, with one processor 410 as an example in FIG. 4.

The device for executing an operation of the interaction method may further include: an input apparatus 430 and an output apparatus 440.

The processor 410, the memory 420, the input apparatus 430, and the output apparatus 440 can be connected by means of a bus or in other manners, with a connection by means of a bus as an example in FIG. 4.

As a non-volatile computer readable storage medium, the memory 420 can be used to store non-volatile software programs, non-volatile computer executable programs and modules, for example, a program instruction/module corresponding to the interaction method in some embodiments of the application. The processor 410 executes various functional applications and data processing of the server, that is, implements the interaction method of the foregoing method embodiments, by running the non-volatile software programs, instructions, and modules stored in the memory 420.

The memory 420 may include a program storage area and a data storage area, where the program storage area may store an operating system and at least one application needed by function; the data storage area may store data for presenting program interaction information related to the information in the currently played program on the client, and the like. In addition, the memory 420 may include a high-speed random access memory, and also may include a non-volatile memory, such as at least one disk storage device, flash storage device, or other non-volatile solid-state storage devices. In some embodiments, the memory 420 optionally includes memories remotely disposed with respect to the processor 410, and the remote memories may be connected, via a network, to the interaction system. Examples of the foregoing network include but are not limited to: the Internet, an intranet, a local area network, a mobile communications network, and a combination thereof.

The input apparatus 430 can receive entered digit or character information, and generate program information relevant to user inputs of the interaction system. The output apparatus 440 may include a display device, for example, a display screen, etc.

The one or more modules are stored in the memory 420, and execute the interaction method in any one of the foregoing method embodiments when being executed by the one or more processors 410.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiments.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

1. An interaction method applied to a terminal, comprising:
when a client is in a shaking state, acquiring information in a currently played program;
the client sending the information in the currently played program to a server; and
the server presenting program interaction information related to the information in the currently played program on the client according to the information in the currently played program.

2. The interaction method according to claim 1, wherein the server presenting the program interaction information related to the information in the currently played program on the client according to the information in the currently played program comprises:
the server searching a program interaction information database according to the information in the currently played program; and
in a case in which the program interaction information related to the information in the currently played program exists in the program interaction information database, presenting the program interaction information related to the information in the currently played program on the client.

3. The interaction method according to claim 1, wherein the client sending the information in the currently played program to a server comprises:
the client incorporating the information in the currently played program in an interaction request to send the interaction request to the server.

4. The interaction method according to claim 2, wherein the server presenting program interaction information related to the information in the currently played program on the client according to the information in the currently played program further comprises:
in a case in which the program interaction information related to the information in the currently played program does not exist in the program interaction information database, presenting at least one of the following on the client:
the program interaction information being expired; and
a prompt for a user to acquire the information in the currently played program again.

5. The interaction method according to claim 1, wherein the information in the currently played program is audio information.

6.-10. (canceled)

11. A non-volatile computer storage medium, which stores computer executables instruction that, when executed by an electronic device, cause the electronic device to:
when a client is in a shaking state, acquire information in a currently played program;
the client send the information in the currently played program to the server; and
the server present program interaction information related to the information in the currently played program on the client according to the information in the currently played program.

12. The non-volatile computer storage medium according to claim 11, wherein the instructions to present program interaction information related to the information in the currently played program on the client according to the information in the currently played program cause the electronic device to:
the server search a program interaction information database according to the information in the currently played program; and
in a case in which the program interaction information related to the information in the currently played program exists in the program interaction information database, present the program interaction information related to the information in the currently played program on the client.

13. The non-volatile computer storage medium according to claim 12, wherein the instructions to send the information in the currently played program to the server cause the electronic device to:
incorporate the information in the currently played program in an interaction request to send the interaction request to the server.

14. The non-volatile computer storage medium according to claim 12, wherein the instructions to present program interaction information related to the information in the currently played program on the client according to the information in the currently played program further cause the electronic device to:
in a case in which the program interaction information related to the information in the currently played program does not exist in the program interaction information database, present at least one of the following on the client:
the program interaction information being expired; and
a prompt for a user to acquire the information in the currently played program again.

15. The non-volatile computer storage medium according to claim 11, wherein the information in the currently played program is audio information.

16. An electronic device, comprising:
at least one processor; and
a memory in communication connection with the at least one processor, wherein:
wherein execution of the instructions by the said at least one processor causes the at least one processor to when a client is in a shaking state, acquire information in a currently played program;
send, by the client, the information in the currently played program to a server; and
present, by the server, program interaction information related to the information in the currently played program on the client according to the information in the currently played program.

17. The electronic device according to claim 16, wherein the execution of the instructions to presenting, by the server, program interaction information related to the information in the currently played program on the client according to the information in the currently played program cause the at least one processor to:
search, by the server, a program interaction information database according to the information in the currently played program; and
in a case in which the program interaction information related to the information in the currently played program exists in the program interaction information database, present the program interaction information related to the information in the currently played program on the client.

18. The electronic device according to claim 17, wherein the execution of the instructions to send, by the client, the information in the currently played program to a server comprises:
incorporate, by the client, the information in the currently played program in an interaction request to send the interaction request to the server.

19. The electronic device according to claim 17, wherein the execution of the instructions to present by the server program interaction information related to the information in the currently played program on the client according to the information in the currently played program further cause the at least one processor to:
in a case in which the program interaction information related to the information in the currently played program does not exist in the program interaction information database, present at least one of the following on the client:
the program interaction information being expired; and
a prompt for a user to acquire the information in the currently played program again.

20. The electronic device according to claim 16, wherein the information in the currently played program is audio information.

21. An interaction system, comprising a client and a server;
wherein when the client is in a shaking state, the client is configured to acquire information in a currently played program and sending the information in the currently played program to the server; and
wherein the server is configured to present program interaction information related to the information in the currently played program on the client according to the information in the currently played program.

22. The interaction system according to claim 21, wherein the server is further configured to search a program interaction information database according to the information in the currently played program; and in a case in which the program interaction information related to the information in the currently played program exists in the program interaction information database, present the program interaction information related to the information in the currently played program on the client.

23. The interaction system according to claim 22, wherein the client is further configured to incorporate the information in the currently played program in an interaction request to send the interaction request to the server.

24. The interaction system according to claim 22, wherein in a case in which the program interaction information related to the information in the currently played program does not exist in the program interaction information database, the server is further configured to present at least one of the following on the client:
the program interaction information being expired; and
a prompt for a user to acquire the information in the currently played program again.

25. The interaction system according to claim 21, wherein the information in the currently played program is audio information.
